(19) United States
(12) Patent Application Publication
(10) Pub. No.: US 2025/0087722 A1
(43) Pub. Date: Mar. 13, 2025

(54) FUEL CELL SYSTEM HAVING A TWO-PHASE COOLING SYSTEM COMPRISING A BYPASS LINE

(71) Applicant: Aerostack GmbH, Dettingen an der Erms (DE)

(72) Inventors: Markus SCHUDY, Dettingen an der Erms (DE); Marcus-Benedict BUNTZ, Dettingen an der Erms (DE); Christoph ZIEGLER, Dettingen an der Erms (DE)

(21) Appl. No.: 18/883,119

(22) Filed: Sep. 12, 2024

(30) Foreign Application Priority Data
Sep. 13, 2023 (DE) 102023124699.2

(51) Int. Cl. H01M 8/04007; H01M 8/04029; H01M 8/24; H01M 50/249

(52) U.S. Cl. CPC H01M 8/04059; H01M 8/04029; H01M 8/24; H01M 50/249

(57) ABSTRACT

A fuel cell system having a two-phase cooling system includes at least one fuel cell having a coolant inlet and a coolant outlet, a condenser in fluid connection with the accumulator to condense and supercool the coolant, a bypass line including a pump, the bypass line being in fluid connection with the coolant outlet and the coolant inlet and being adapted to return the coolant to the fuel cell by a pump.

### TECHNICAL FIELD

The disclosure herein relates in general to the technical field of aviation. In particular, the description relates to a fuel cell system having two-phase cooling comprising a bypass line and to an aircraft comprising such a fuel cell system.

### BACKGROUND

Fuel cells are a possible solution for generating power in aircraft propulsion systems or emission-free auxiliary power units (APU) without unwanted emissions. Polymer electrolyte membrane fuel cells (PEMFC) generate energy and power through the electrochemical reaction of hydrogen and oxygen to form water. This reaction involves the unavoidable generation of heat, which must be dissipated. This is realized by liquid cooling in commercial fuel cell stacks.

A potential alternative with a potential for considerable weight reduction at the system level is to replace liquid cooling with two-phase cooling. Use is made here of the latent heat of evaporation to dissipate large amounts of heat from the fuel cells. In addition, the high heat transfer coefficient improves the performance of the thermal management system compared to single-phase cooling. Two-phase cooling is based on the phase transitions in the evaporator (fuel cells) and in the heat exchanger in relation to the environment (condenser). In order to be able to pump the coolant to the fuel cell, the coolant must be supercooled, i.e., it must be in the liquid state (avoiding pump cavitation). Supercooling refers to the temperature range below the boiling point of the coolant. The supercooled coolant then reaches the fuel cell, where its temperature is increased and the coolant begins to boil. The presence of this steep temperature gradient in the inlet zone can cause damage to the fuel cell. Excessively low temperatures in this region can lead to condensation of water in the gas ducts (flooding). In order to overcome this risk and other risks, a preheater or recuperator is generally used upstream of the evaporator (fuel cell). However, the preheater/recuperator can be prohibitively large and reduce the weight benefits of two-phase cooling.

### SUMMARY

It can be considered to be an object of the disclosure herein to provide a fuel cell system having reduced weight.

This object is achieved by the subject matter and embodiments disclosed herein.

According to one aspect, a fuel cell system having a two-phase cooling system is specified. The fuel cell system comprises at least one fuel cell having a coolant inlet and a coolant outlet. It further comprises an accumulator, the accumulator being in fluid connection with the fuel cell and being adapted to contain coolant which flows out of the fuel cell in a gas phase in a first portion and in a liquid phase in a second portion. It further comprises a condenser, the condenser being in fluid connection with the accumulator and being adapted to condense and supercool the coolant. It further comprises a bypass line comprising a pump, the coolant inlet being in fluid connection with the coolant outlet via the bypass line.

A fuel cell system in the context of the disclosure herein is a technological unit which consists of multiple components and is used to convert chemical energy into electrical energy by electrochemical reactions. It generally comprises one or more fuel cells which act as electrochemical cells and are the main component of the system. In addition, the system contains further components such as a fuel supply mechanism, an oxidizer supply mechanism, an electrolyte solution, electrodes, a catalyst and an electrical connection.

The fuel cell system uses a chemical reaction between a fuel and an oxidizer, typically hydrogen and oxygen, in order to generate electrochemical power. This produces water as the only waste product, which makes the fuel cell system an environmentally friendly source of energy. The electrical energy generated can then be used to supply electrical devices, to supply vehicles or to generate power in various applications.

A two-phase cooling system in the context of the disclosure herein is a cooling solution intended for efficient dissipation of large amounts of heat by use of the phase transition from liquid to vapor. It is frequently used in situations where conventional single-phase cooling systems reach their limits and cannot provide sufficient heat dissipation.

A two-phase cooling system uses a coolant which can exist in both liquid and gaseous form at appropriate temperatures and pressures. The coolant absorbs heat from the source to be cooled and evaporates, thereby transitioning from a liquid state to a gaseous state. The resultant vapor absorbs large amounts of heat.

The phase change from liquid to vapor allows effective heat transfer, since evaporation has a higher heat transfer potential than convective liquid cooling. This leads to improved cooling performance and to more efficient heat dissipation.

A two-phase cooling system generally consists of an evaporator, in which the coolant absorbs heat and evaporates, and a condenser, in which the vapor recondenses and releases the heat. The condensate is then returned to the evaporator to continue the cooling circuit.

This type of cooling system is used in various applications, including the cooling of high-performance electronics, processors, fuel cells, engines and other thermally demanding systems where efficient heat dissipation is of great importance.

An accumulator in the context of the disclosure herein is a component or device used to carry out phase separation between gas phase and liquid phase on the basis of gravity.

One or more flows containing gas and liquid are combined or supplied in an accumulator. Owing to gravity, a separating force acts on the phases of different densities. As a result of this, the heavier medium (usually the liquid) accumulates at the bottom of the accumulator, whereas the lighter medium (usually the gas) is present in the upper region of the accumulator.

A possible accumulator is a heat-controlled accumulator (HCA). Such an accumulator comprises a volume filled with vapor and liquid of a single working fluid without a diaphragm being present. The pressure in an HCA is controlled by a heater.

Another possible accumulator is a pressure-controlled accumulator (PCA). Such an accumulator comprises a volume pressurized mechanically by a piston or by gaseous pressure (with a bladder or diaphragm).

The accumulator is designed to allow efficient separation and accumulation of the two phases. This can be achieved by using gravity separators, partitions, funnels or other specific structures. The goal is to ensure that the gas and the liquid are separated and are collected in separate regions to allow effective use or further processing.

A condenser is a component or device used to condense vapor or gas into a liquid phase. The condenser is in fluid connection with the accumulator, which means that the coolant can circulate between the two components.

The main function of the condenser is to condense the coolant by release of heat and thus transition from a gaseous state to a liquid state. This process is generally done by cooling of the vapor or gas by contacting thereof with a medium of lower temperature via the condenser. This cooling causes the molecules of the vapor or gas to come together and condense, as a result of which they are collected in liquid form.

Furthermore, the condenser is adapted such that it can supercool the coolant. Supercooling means that the temperature of the condensed coolant is below its saturation point, i.e., below the temperature at which it would normally condense. This allows more heat to be absorbed by the coolant before it evaporates once again or is passed on. Supercooling is important for avoiding cavitation at the pump.

A pump is a unit or device used to convey or move liquids or gases from one location to another. In the present case, the pump is specifically adapted to convey the supercooled coolant.

The main function of a pump is to exert mechanical energy on the coolant in order to move it along a line or through a system. The pump generates a pressure gradient or flow gradient which conveys the coolant from a region of higher pressure to a region of lower pressure. This is done by transferring kinetic energy or by changing the volume of the pump in order to draw in the coolant and then push it in the desired direction.

In the specific case of supercooled coolant, the pump is configured to receive the liquid phase of the coolant and transfer it along the system. The pump must be capable of handling the low pressure of the supercooled coolant and building up enough pressure to convey it through the system. This allows continuous circulation of the supercooled coolant in order to maintain the desired cooling effect.

There are various types of pumps that are suitable for different applications and fluids, such as centrifugal pumps, piston pumps or screw pumps. The selection of the correct pump depends on the specific requirements of the system, including the flow volume, the pressure range and the type of coolant.

A bypass line is a line or pipe which is in fluid connection with a coolant inlet and a coolant outlet and is used to guide warm coolant directly to cold coolant without it having to flow through the main path of the cooling circuit. The bypass line makes it possible to achieve specific circumvention of the normal cooling circuit and to conduct the warm cooling medium directly to the cold cooling medium.

This allows rapid and efficient heat transfer for effective increasing of the temperature of the cooling medium. The bypass line may be used in various applications to allow specific cooling or specific temperature control and to make a preheater/recuperator dispensable.

According to one embodiment, the bypass line comprises a control valve, in particular a thermostatic valve.

A bypass line in conjunction with a control valve provides various advantages for the cooling system. The control valve acts as a control valve and allows precise control of the cooling circuit on the basis of temperature. This ensures effective temperature control.

A major advantage is the precise temperature control. The control valve allows the exact setting of the coolant temperature by control of the flow rate of the cooling medium in the bypass line. This ensures an optimal operating temperature and improves the efficiency of the system.

Another advantage is the fast response time of the control valve. It can respond rapidly to changes in temperature and adjust the flow rate of the cooling medium accordingly. This allows the system to respond quickly to changing operating conditions and to avoid overheating or undercooling.

The use of a bypass line in conjunction with a control valve can also lead to energy savings. The control valve controls the cooling circuit in a specific manner and conducts the cooling medium directly from the coolant outlet to the coolant inlet. This reduces flow through the rest of the system, which leads to more efficient cooling and to energy savings.

Furthermore, the use of a control valve can extend the service life of the components in the cooling circuit. The precise temperature control and the avoidance of overheating or undercooling protects the components and improves their reliability and service life.

The combination of bypass line and control valve makes the cooling system more flexible and adaptable. The control valve allows the setting of various temperature ranges and cooling levels in order to satisfy the different operating conditions.

Another advantage is that gas bubbles are supplied in the inflow to the coolant inlet of the fuel cell and they have a number of advantages for counteracting superheating of the coolant. They help to reduce surface tension, which leads to more effective heat exchange at higher temperatures.

Altogether, the use of a bypass line with a control valve provides precise and efficient cooling with improved control of the operating temperature. This leads to better performance, reductions in mass, and a longer service life of the system.

According to one embodiment, the bypass line comprises a preheating module.

A bypass line comprising a preheating module is a cooling system configuration which provides additional advantages. The preheating module is a component which is integrated into the bypass line and is used to preheat the cooling medium before it is returned to the main cooling circuit. In the following, this configuration is defined and the advantages thereof are indicated.

The bypass line is a connection between the coolant outlet and the coolant inlet that runs parallel to the main cooling circuit. The preheating module is a unit within the bypass line that has been specifically developed to preheat the cooling medium.

Another advantage is that condensation problems are reduced. In certain situations, especially in the case of cooler temperatures or high air humidity, condensation can occur in the cooling circuit. The preheating module brings the cooling medium to a higher temperature, thereby reducing the risk of condensation and stabilizing the performance of the system.

The use of a preheating module in the bypass line also allows a faster heat-up time for the cooling circuit. Since the medium has already been preheated before it enters the main cooling circuit, the system reaches the desired operating temperature more quickly. This is particularly advantageous when cold-starting the system or when recovering after shutdown.

Another advantage is that temperature control is possible. The preheating module can be equipped with a control valve which controls the flow rate or temperature of the preheated cooling medium. This allows the operating temperature of the system to be precisely controlled and adapted to the specific requirements.

In summary, a bypass line comprising a preheating module provides improved thermal efficiency, reduced condensation problems, a faster heat-up time and precise temperature control. This configuration can lead to optimized performance and mass efficiency of the cooling system, while ensuring a more stable operating environment.

According to one embodiment, the fuel cell comprises a fuel cell stack having a media module, and the media module comprises the bypass line and the pump.

According to one embodiment, the fuel cell is a fuel cell stack having at least one base plate, and the base plate comprises the bypass line and the pump.

According to one embodiment, the coolant comprises methanol and/or ethanol.

Methanol and ethanol have various advantages as coolants. The two substances have a relatively low boiling point, meaning that they can evaporate at relatively high temperatures and thus allow better cooling.

Another advantage is the low viscosity of methanol compared to water. This facilitates flow and reduces the energy consumption of the pump.

Furthermore, methanol and ethanol have a high enthalpy of evaporation. This allows realization of very small mass flow rates in the system, thereby reducing pressure loss. This means that lines and pumps can be dimensioned smaller than with liquid cooling, which leads to a reduction of weight in the system.

According to one aspect, an aircraft comprises a fuel cell system of the aforementioned construction.

According to one embodiment, the fuel cell system further comprises an ejector, the ejector being in fluid connection with the first portion of the accumulator, with the second portion of the accumulator, with the pump, with the condenser and with the fuel cell and being adapted to mix the coolant in the gas phase from the accumulator with the supercooled coolant from the condenser and to supply the coolant to the fuel cell.

The main function of the ejector is to mix the coolant in the gas phase from the first portion of the accumulator with the supercooled coolant from the condenser and to then supply the coolant to the fuel cell. The ejector uses the pressure difference between the two fluids in order to draw in the coolant in the gas phase and mix it with the supercooled coolant.

The ejector plays a crucial role in mixing and supplying the coolant in the gas phase with the supercooled coolant in the system. It allows efficient use of the available pressure difference and ensures uniform distribution of the coolant for cooling of the fuel cell.

Another advantage is the formation of gas bubbles in the coolant system, which are advantageous for counteracting superheating of the coolant. They help to reduce surface tension, which leads to more effective heat exchange at higher temperatures.

According to one embodiment, the fuel cell system further comprises a thermally conductive element between the coolant inlet and the coolant outlet, the thermally conductive element being adapted to transfer heat from the coolant outlet to the coolant inlet.

The main advantage of a thermally conductive element between the coolant inlet and the coolant outlet is efficient heat transfer. The use of a thermally conductive element allows effective transfer of the heat present in the coolant outlet to the coolant inlet. This improves heat dissipation and stabilizes the temperature in the cooling circuit by preheating of the cooling fluid.

### BRIEF DESCRIPTION OF THE DRAWINGS

Example embodiments of the disclosure herein are discussed in more detail below with reference to the appended drawings. The illustrations are schematic and not true to scale. The same reference signs denote identical or similar elements. In the figures:

FIG. 1 shows a fuel cell system;

FIG. 2 shows another fuel cell system;

FIG. 3 shows another fuel cell system; and

FIG. 4 shows an aircraft.

### DETAILED DESCRIPTION

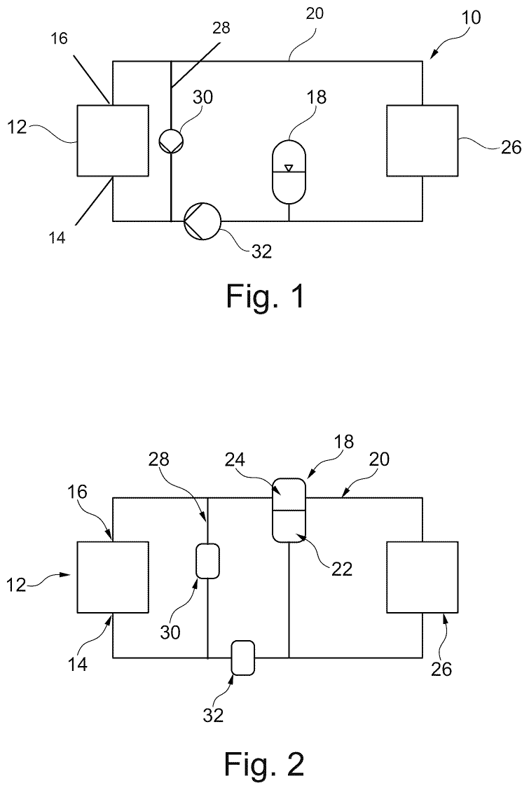

FIG. 1 shows a fuel cell system 10 having a two-phase cooling system. The system comprises at least one fuel cell 12 which has a coolant inlet 14 and a coolant outlet 16. A bypass connection 28 between the coolant inlet and the coolant outlet allows flow of the coolant.

The system 10 also contains an accumulator 18 which is in fluid connection with the fuel cell 12. The accumulator is designed to receive the coolant which flows out of the fuel cell and to apply pressure to the cooling system.

In addition, the system 10 comprises a condenser 26 which is in fluid connection with the accumulator 18. The condenser condenses and supercools the coolant to ensure efficient cooling.

The system also has a bypass line 28 comprising a pump 30. It is through the bypass line that the coolant inlet 14 is connected to the coolant outlet 16.

Furthermore, the example shown comprises the condenser pump 32 adapted to convey the coolant 20.

The bypass line 28 makes it possible to achieve specific circumvention of the normal cooling circuit and to conduct the warm cooling medium directly to the cold cooling medium.

This allows rapid and efficient heat transfer for effective lowering of the temperature of the cooling medium. The bypass line 28 may be used in various applications to allow specific cooling or specific temperature control and to make a preheater/recuperator dispensable.

FIG. 2 shows another embodiment of a fuel cell system 10 equipped with an efficient two-phase cooling system. The system comprises at least one fuel cell 12 which has a coolant inlet 14 and a coolant outlet 16. A connection between the coolant inlet and the coolant outlet allows flow of the coolant.

The system 10 also contains an accumulator 18 which is in fluid connection with the fuel cell 12. The accumulator is designed to receive the coolant which flows out of the fuel cell. The coolant is kept in a gas phase in the first portion of the accumulator 22, whereas it is in a liquid phase in the second portion 24.

In addition, the system 10 comprises a condenser 26 which is in fluid connection with the accumulator 18. The condenser condenses and supercools the coolant to ensure efficient cooling.

The system also has a bypass line 28 comprising a pump 30. It is through the bypass line that the coolant inlet 14 is connected to the coolant outlet 16.

Furthermore, the example shown comprises a condensate pump 32 adapted to convey the coolant 20.

The bypass line 28 makes it possible to achieve specific circumvention of the normal cooling circuit and to conduct the warm cooling medium directly to the cold cooling medium.

This allows rapid and efficient heat transfer for effective lowering of the temperature of the cooling medium. The bypass line 28 may be used in various applications to allow specific cooling or specific temperature control and to make a preheater/recuperator dispensable.

The major difference compared to the embodiment of FIG. 1 is that the accumulator is connected to the return line and, as a result, the gas phase can be mixed with the liquid phase.

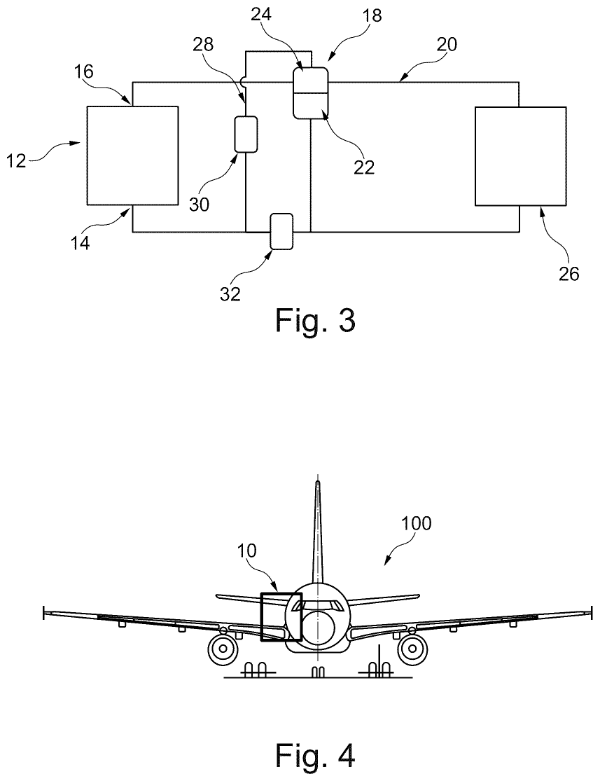

FIG. 3 shows another embodiment of a fuel cell system 10 equipped with an efficient two-phase cooling system. The fuel cell system 10 likewise comprises at least one fuel cell 12 which has a coolant inlet 14 and a coolant outlet 16.

The major difference compared to the embodiment relating to FIG. 1 and FIG. 2 is phase separation in the accumulator and the specific injection of the vapor phase via the ejector toward the inlet of the fuel cell.

FIG. 4 shows an aircraft 100 comprising a fuel cell system 10 as described.

It should additionally be pointed out that “comprising” or “having” does not rule out other elements or steps, and “a”, “an” or “one” does not rule out a multiplicity. It is furthermore pointed out that features or steps that have been described with reference to one of the above example embodiments may also be used in combination with other features or steps of other example embodiments described above. Reference signs in the claims should not be interpreted as restricting.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 Fuel cell system
12 Fuel cell
14 Coolant inlet
16 Coolant outlet
18 Accumulator
20 Coolant
22 First portion
24 Second portion
26 Condenser
28 Bypass line
30 Pump
32 Condensate pump
100 Aircraft

1. A fuel cell system having a two-phase cooling system, comprising:
at least one fuel cell having a coolant inlet and a coolant outlet;
a condenser to condense and supercool a coolant;
a condensate pump to convey the supercooled coolant; and
a bypass line in fluid connection with the coolant outlet and the coolant inlet and being configured to return the coolant to the fuel cell by a pump.

2. The fuel cell system of claim 1, further comprising an accumulator for phase separation into gas phase and liquid phase to take place in the accumulator, the accumulator being in fluid connection with the fuel cell and being adapted to contain coolant which flows out of the fuel cell in a gas phase in a first portion and in a liquid phase in a second portion.

3. The fuel cell system of claim 1, wherein the bypass line comprises a control valve.

4. The fuel cell system of claim 1, wherein the bypass line comprises a preheating module.

5. The fuel cell system of claim 1, wherein the fuel cell comprises a fuel cell stack having a media module, and the media module comprises the bypass line and the pump.

6. The fuel cell system of claim 1, wherein the fuel cell is a fuel cell stack having at least one base plate, and the base plate comprises the bypass line and the pump.

7. The fuel cell system of claim 1, wherein the coolant comprises methanol and/or ethanol.

8. An aircraft comprising the fuel cell system of claim 1.
